(19) United States
(12) Patent Application Publication
(10) Pub. No.: US 2012/0250601 A1
(43) Pub. Date: Oct. 4, 2012

(54) COMMUNICATION TERMINAL, METHOD FOR EXCHANGING DATA, COMMUNICATION DEVICE AND METHOD FOR ESTABLISHING A COMMUNICATION CONNECTION

(76) Inventors: Hyung-Nam Choi, Hamburg (DE); Maik Bienas, Braunschweig (DE); Andreas Schmidt, Braunschweig (DE)

(21) Appl. No.: 13/072,838

(22) Filed: Mar. 28, 2011

(51) Int. Cl. H04W 72/04; H04B 7/14

(52) U.S. Cl. 370/315; 370/329

(57) ABSTRACT

A communication terminal is described comprising a communication module configured to establish an NAS bearer connection between the communication terminal and a core network of a cellular mobile communication network and a controller configured to control the communication terminal to dedicatedly use the NAS bearer connection to exchange data between at least one second communication terminal communicating with the communication terminal and the core network.

### TECHNICAL FIELD

Embodiments generally relate to a communication terminal, a method for exchanging data, a communication device and a method for establishing a communication connection.

### BACKGROUND

In wireless communication networks, communication terminals may act as relay nodes (i.e. relay communication devices) for various reasons such as expansion of coverage area, more efficient radio resource usage, or increase of communication quality. Flexible and efficient ways to use relaying in communication networks are desirable.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments are described with reference to the following drawings, in which:

FIG. 1 shows communication system according to an embodiment.

FIG. 2 shows a state transition diagram according to an embodiment.

FIG. 3 shows a protocol structure according to an embodiment.

FIG. 4 shows a communication system according to an embodiment.

FIG. 5 shows a message flow diagram according to an embodiment.

FIG. 6 shows a protocol structure according to an embodiment.

FIG. 7 shows a communication system according to an embodiment.

FIG. 8 shows a protocol stack architecture according to an embodiment.

FIG. 9 shows a protocol stack architecture according to an embodiment.

FIG. 10 shows a communication terminal according to an embodiment.

FIG. 11 shows a flow diagram according to an embodiment.

FIG. 12 shows a message flow diagram according to an embodiment.

FIG. 13 shows a protocol architecture according to an embodiment.

FIG. 14 shows a message flow diagram according to an embodiment.

FIG. 15 shows a message flow diagram according to an embodiment.

### DESCRIPTION

The following detailed description refers to the accompanying drawings that show, by way of illustration, specific details and embodiments in which the invention may be practiced. These embodiments are described in sufficient detail to enable those skilled in the art to practice the invention. Other embodiments may be utilized and structural, logical, and electrical changes may be made without departing from the scope of the invention. The various embodiments are not necessarily mutually exclusive, as some embodiments can be combined with one or more other embodiments to form new embodiments.

3GPP (3rd Generation Partnership Project) has introduced LTE (Long Term Evolution) into the Release 8 version of UMTS (Universal Mobile Telecommunications System) standards. With LTE the UMTS air interface is further optimized for packet data transmission by improving the system capacity and the spectral efficiency. Amongst others, the maximum net transmission rate is increased significantly, namely to 300 Mbps in the downlink transmission direction and to 75 Mbps in the uplink transmission direction. Further, LTE supports scalable bandwidths of 1.4, 3, 5, 10, 15, and 20 MHz and is based on the multiple access methods OFDMA/TDMA (orthogonal frequency division multiple access/time division multiple access) in downlink and SC-FDMA/TDMA (single carrier-frequency division multiple access/TDMA) in uplink. OFDMA/TDMA is a multicarrier multiple access method in which a subscriber is provided with a defined number of subcarriers in the frequency spectrum and a defined transmission time for the purpose of data transmission. The RF bandwidth capability of an LTE UE (user equipment) for transmission and reception has been set to 20 MHz. A physical resource block (PRB) is the baseline unit of allocation for the physical channels defined in LTE. A physical resource block includes a matrix of 12 subcarriers by 6 or 7 OFDMA/SC-FDMA symbols. A pair of one OFDMA/SC-FDMA symbol and one subcarrier is denoted as resource element.

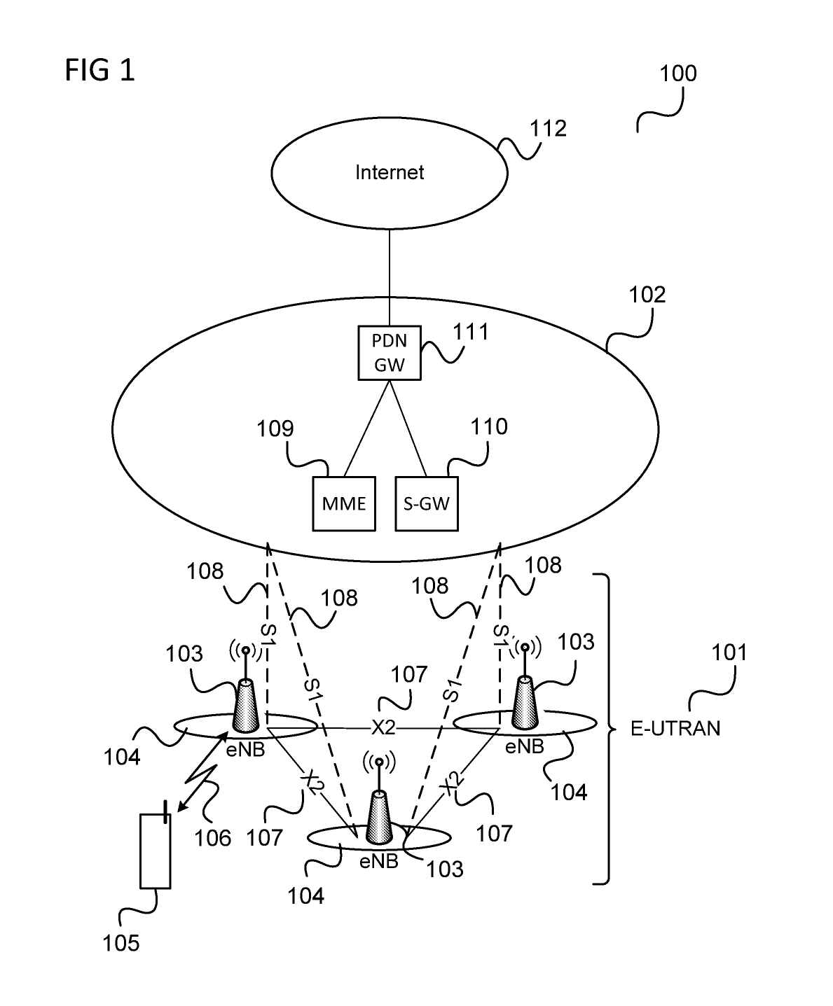

FIG. 1 shows a communication system 100 according to an embodiment.

According to this embodiment, the communication system 100 is configured in accordance with the network architecture of LTE. The communication system 100 may also be configured according to another communication standard, e.g. according to UMTS (Universal Mobile Telecommunications System), GSM (Global System for Mobile Communications), CDMA2000 (CDMA: Code Division Multiple Access), or FOMA (Freedom of Mobile Access).

The communication system 100 includes a radio access network (in this example, according to LTE an E-UTRAN, Evolved UMTS Terrestrial Radio Access Network) 101 and a core network (in this example, according to LTE an EPC, Evolved Packet Core) 102. The E-UTRAN 101 may include base (transceiver) stations (in this example, according to LTE eNodeBs, eNBs) 103. Each base station 103 provides radio coverage for one or more mobile radio cells 104 of the E-UTRAN 101.

A mobile terminal (in this example, according to LTE a UE, user equipment) 105 located in a mobile radio cell 104 may communicate with the core network 102 and with other mobile terminals 105 via the base station 103 providing coverage (in other words operating) in the mobile radio cell.

Control and user data are transmitted between a base station 103 and a mobile terminal located in the mobile radio cell 104 operated by the base station 103 over the air interface 106 on the basis of a multiple access method.

The base stations 103 are interconnected with each other by means of the X2 interface 107. The base stations are also connected by means of the S1 interface 108 to the core network (Evolved Packet Core) 102, more specifically to an MME (Mobility Management Entity) 109 and a Serving Gateway (S-GW) 110.

The MME is responsible for controlling the mobility of the mobile terminal 105 located in the coverage area of the E-UTRAN 101 and bearer management functions, while the S-GW 110 is responsible for i) handling the transmission of user data between the mobile terminal 105 and the core network 102 and ii) Uplink and Downlink charging per mobile terminal, PDN (Packet Data Network), and QCI (Quality of Service Identifier). In this example of a core network 102 according to LTE (i.e. an EPC, Evolved Packet Core) the MME 109 and the S-GW 110 are connected to a PDN GW (Packet Data Network Gateway) 111, also referred to as P-GW, of the core network 102 that provides connectivity to external packet data networks such as the Internet 112. Further, the PDN GW 111 is responsible for IP address allocation to the mobile terminal 105, and uplink and downlink service level charging.

In one embodiment, according to LTE, the communication system 100 supports the following types of duplexing methods: full-duplex FDD (frequency division duplexing), half-duplex FDD and TDD (time division duplexing).

According to full-duplex FDD two separate frequency bands are used for uplink (UL) transmission (i.e. transmission from mobile terminal 105 to base station 103) and downlink (DL) transmission (i.e. transmission from base station 103 to mobile terminal 105) and both transmissions can occur simultaneously. According to half-duplex FDD also two separate frequency bands are used for uplink and downlink transmissions, but both transmissions are non-overlapping in time. According to TDD the same frequency band is used for transmission in both uplink and downlink. Within a time frame the direction of transmission may be switched alternatively between downlink and uplink.

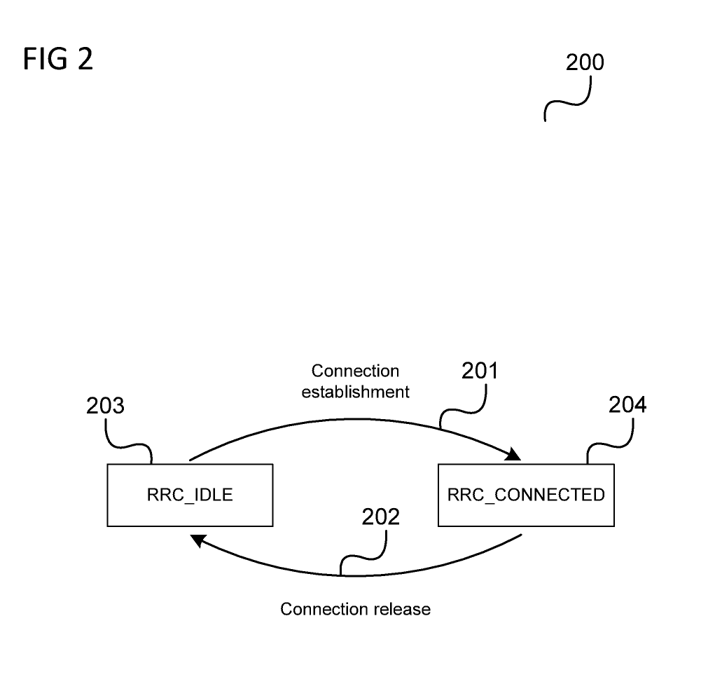

For the efficient control of radio resources and communication connections between a mobile terminal 105 and a base station (eNodeB) 103 two connection states are in one embodiment, according to LTE, specified at the RRC protocol layer, the state RRC_IDLE (also referred to as idle mode) and the state RRC_CONNECTED (also referred to as connected mode). These RRC states and the transitions between these states are illustrated in FIG. 2.

FIG. 2 shows a state transition diagram 200 according to an embodiment.

A first state transition 201 from RRC_IDLE state 203 to RRC_CONNECTED state 204 for example occurs when a communication connection is established between the respective mobile terminal 105 and the respective base station 103.

A second state transition 202 from RRC_CONNECTED state 204 to RRC_IDLE state 203 for example occurs when a communication connection between the respective mobile terminal 105 and the respective base station 103 is released.

RRC_CONNECTED state 204 and RRC_IDLE state 203 may for example be characterized as follows.

RRC_IDLE:
No RRC connection is established
The UE position (i.e. the position of the respective mobile terminal 105) is known by the network (i.e. the E-UTRAN 101 and/or the core network 102) at tracking area level (a tracking area defines a group of radio cells 104 where the mobile terminal 105 in RRC_IDLE state registers and where the mobile terminal 105 is paged in case of an incoming communication attempt);
The mobile terminal 105 performs cell (re-)selection;
The mobile terminal 105 acquires system information which is broadcast in the radio cell 104;
No transmission of user and control data in uplink and downlink by the mobile terminal 105 and the base station 103;
The mobile terminal 105 monitors a paging channel to receive notification about incoming calls or modification of system information;

RRC_CONNECTED:
An RRC connection is established between the mobile terminal 105 and the base station 103;
The mobile terminal 105 is connected to one radio cell 104 only and based on measurements reported by the mobile terminal 105 (e.g. received signal strength of reference signals of detected neighboring radio cells 104) network controlled mobility is performed by explicit handover and cell change order;
The mobile terminal 105 position is known by the network at cell area level;
The mobile terminal 105 acquires system information which are broadcast in the radio cell;
Transmission of user and control data in uplink and downlink;
The mobile terminal 105 monitors a paging channel to receive notification about modification of system information.

The RRC connection is defined as a point-to-point bidirectional connection between RRC peer entities in the mobile terminal 105 and the base station 103. According to one embodiment, there is either none or one RRC connection between a mobile terminal and a base station.

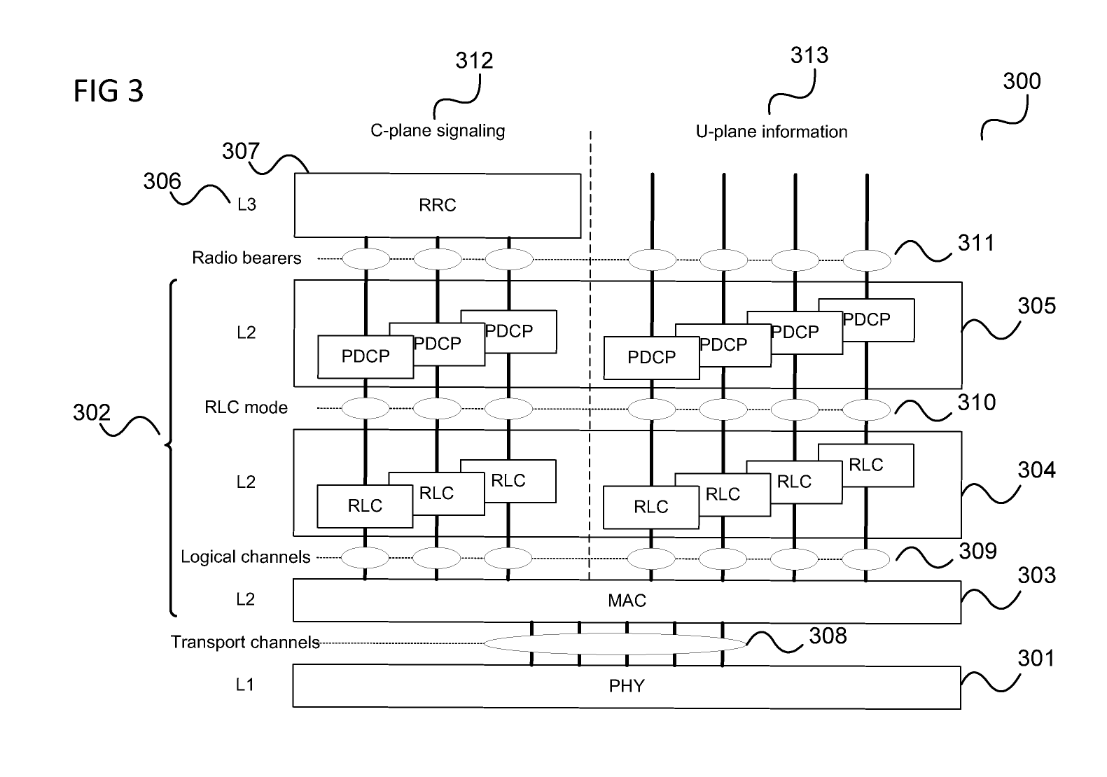

The radio protocol architecture of an air interface 106 according to LTE (denoted as Uu air interface) is illustrated in FIG. 3.

FIG. 3 shows a protocol structure 300 according to an embodiment.

The protocol structure 300 is also referred to as Access Stratum (AS). The Uu air interface is logically divided into three protocol layers. The entities ensuring and providing the functionality of the respective protocol layers are implemented both in the mobile terminal 105 and the base station 103.

The protocol structure includes as bottommost layer the physical layer PHY 301, which represents the protocol layer 1 (L1) according to the OSI (Open System Interconnection) reference model. The protocol layer arranged above the physical layer 301 is the data link layer 302, which represents the protocol layer 2 (L2) according to the OSI reference model. In detail, the data link layer 302 includes of a plurality of sub layers, namely the Medium Access Control (MAC) sub layer 303, the Radio Link Control (RLC) sub layer 304 and the Packet Data Convergence Protocol (PDCP) sub layer 305. The topmost layer of the Uu air interface is the network layer 306, which is the protocol layer 3 (L3) according to the OSI reference model and includes the Radio Resource Control (RRC) layer 307.

Each protocol (sub-)layer 301 to 307 provides the protocol (sub-)layer above it with its services via defined service access points 308 to 311.

To provide a better understanding of the protocol layer architecture, the service access points have been provided with generally customary and unambiguous names: The PHY provides its services to MAC via transport channels, the MAC provides its services to RLC via logical channels, and the RLC provides its services to RRC and PDCP as data transfer as function of the RLC mode, i.e. TM (Transparent Mode), UM (Unacknowledged Mode) and AM (Acknowledged Mode). Further, the PDCP provides its services to RRC layer 307 and user plane upper layers via radio bearers, specifically via signaling radio bearers (SRB) to RRC 307 and via data radio bearers (DRB) to user plane upper layers. LTE currently supports a maximum of 3 SRBs and 11 DRBs.

The LTE radio protocol architecture as illustrated in FIG. 3 is split not just horizontally into the above-described protocol layers 301 to 307, but also vertically into a control plane (C-plane) 312 and a user plane (U-plane) 313. The entities of the control plane are used to handle the exchange of signaling data between the mobile terminal 105 and the base station 103 which are required among other for the establishment, reconfiguration and release of physical channels, transport channels, logical channels, signaling radio bearers and data radio bearers, whereas the entities of the user plane are used to handle the exchange of user data between the mobile terminal 105 and the base station 103.

Each protocol layer 301 to 307 has particular prescribed functions:
The physical layer (or PHY layer) 301 is responsible among other for i) error detection on the transport channel; ii) channel encoding/decoding of the transport channel; iii) Hybrid ARQ (Automatic Repeat Request) soft combining; iv) mapping of the coded transport channel onto physical channels; v) modulation and demodulation of physical channels.
The MAC layer 303 is responsible among other for i) mapping between logical channels and transport channels; ii) error correction through HARQ; iii) logical channel prioritization; iv) transport format selection.
The RLC layer 304 is responsible among other for i) error correction through ARQ, ii) concatenation, segmentation and reassembly of RLC SDUs (Service Data Units); iii) re-segmentation and reordering of RLC data PDUs (Protocol Data Units). Further, the RLC is modeled such that there is an independent RLC entity for each radio bearer (data or signaling).
The PDCP layer 305 is responsible for header compression and decompression of IP (Internet Protocol) data flows, ciphering and deciphering of user plane data and control plane data, and integrity protection and integrity verification of control plane data. The PDCP is modeled such that each radio bearer (i.e. data radio bearer and signaling radio bearer, except for the signaling radio bearer SRB0) is associated with one PDCP entity. Each PDCP entity is associated with one or two RLC entities depending on the radio bearer characteristic (i.e. uni-directional or bi-directional) and RLC mode.
The RRC layer 307 is responsible for the control plane signaling between the mobile terminal 105 and the base station 103 and performs among other the following functions: i) broadcast of system information, ii) paging, iii) establishment, reconfiguration and release of physical channels, transport channels, logical channels, signaling radio bearers and data radio bearers. Signaling radio bearers are used for the exchange of RRC messages between the mobile terminal 105 and the base station 103.

If the mobile terminal 105 located in an LTE radio cell 104 is using an end-to-end communication service provided by the mobile communication network (i.e. the radio access network 101 and the core network 102), e.g. with an external packet data network (PDN) such as the Internet 112, the core network 102 provides this communication service at a defined QoS (Quality of Service) based on the quality criteria of the relevant communication service. This is done by establishing an EPS (Evolved Packet System) bearer context between the mobile terminal 105 and the core network 102. An EPS bearer may be defined as an information transmission path between the mobile terminal 105 and the core network 102 (including the MME 109, S-GW 110 and PDN Gateway 111) associated with certain QoS attributes.

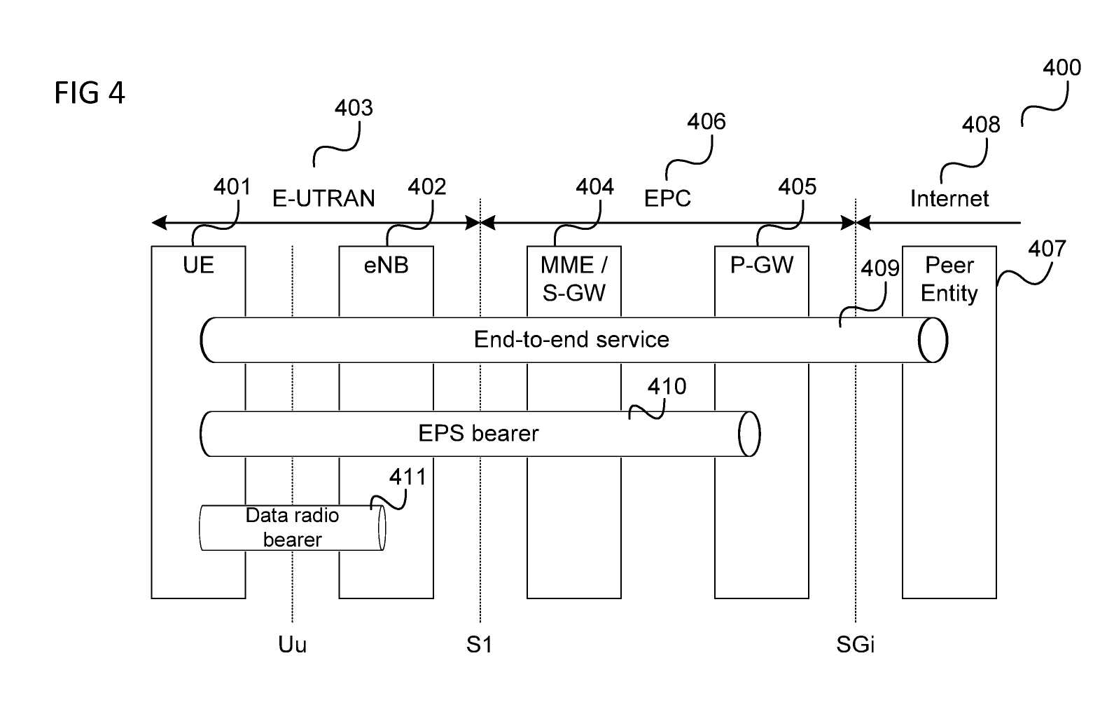

This is illustrated in FIG. 4.

FIG. 4 shows a communication system 400 according to an embodiment.

The communication system 400 includes a mobile terminal 401 and a base station 402 being part of an E-UTRAN 403, analogously to the radio access network 101 of FIG. 1. Further, the communication arrangement 400 includes an MME and/or S-GW 404 and a P-GW 405 being part of an EPC 406, analogously to the core network 102 of FIG. 1. Further, the communication system 400 includes a peer entity 407 which is part of the Internet 408, such as a server computer in the Internet 408.

An end-to-end service 409 may be provided by the communication network (including the radio access network 403 and the core network 406) between the mobile terminal 401 and the peer entity 407.

The end-to-end service 409 may also be seen as a packet data network connection.

The end-to-end service 409 is provided by means of an EPS bearer 410, whose management in terms of establishment, release and maintenance is handled on NAS (Non Access Stratum) level or network layer, which is the protocol layer 3 (L3) according to the OSI reference model.

On radio air interface level or access stratum level the EPS bearer 410 is mapped to a data radio bearer (DRB) 411. In detail, the QoS attributes of the EPS bearer 410 are translated into the QoS attributes of the data radio bearer 411, such as guaranteed bit rate, maximum bit rate, RLC mode and logical channel priority.

FIG. 4 can be seen to show the EPS bearer service architecture from mobile terminal perspective.

In one embodiment, in accordance with LTE, two types of EPS bearer are defined: default bearer and dedicated bearer. The default bearer is established to provide the mobile terminal 105 with always-on IP connectivity to a PDN (such as the Internet 112), and remains established throughout the lifetime of the PDN connection. Any additional EPS bearer that is established to the same PDN is referred to as a dedicated bearer. According to one embodiment, the decision to establish or modify a dedicated bearer can only be taken by the core network 102, and the bearer level QoS attributes are always assigned by the core network 102.

According to one embodiment, each EPS bearer is associated with a QoS Class Identifier (QCI) that is a scalar used as a reference to node-specific parameters that control EPS bearer level packet forwarding treatment (e.g. scheduling weights, admission thresholds, queue management thresholds, link layer protocol configuration, etc.). In accordance with LTE, nine standardized QoS class identifiers with corresponding characteristics for classifying communication services are defined, which differ in terms of their specific transmission properties and quality requirements. The one-to-one mapping of standardized QCI values to standardized characteristics is illustrated in table 1.

TABLE 1

| | | | | Packet | |
|---|---|---|---|---|---|
| | Re- | | Packet | Error | |
| | source | Pri- | Delay | Loss | |
| QCI | Type | ority | Budget | Rate | Example Services |
| 1 | GBR | 2 | 100 ms | 10⁻² | Conversational Voice |
| 2 | | 4 | 150 ms | 10⁻³ | Conversational Video |
| | | | | | (Live Streaming) |
| 3 | | 3 | 50 ms | 10⁻³ | Real Time Gaming |
| 4 | | 5 | 300 ms | 10⁻⁶ | Non-Conversational Video |
| | | | | | (Buffered Streaming) |
| 5 | Non- | 1 | 100 ms | 10⁻⁶ | IMS Signaling |
| 6 | GBR | 6 | 300 ms | 10⁻⁶ | Video (Buffered Streaming) |
| | | | | | TCP-based (e.g., www, |
| | | | | | e-mail, chat, ftp, p2p |
| | | | | | file sharing, progressive |
| | | | | | video, etc.) |
| 7 | | 7 | 100 ms | 10⁻³ | Voice, Video (Live |
| | | | | | Streaming), Interactive |
| | | | | | Gaming |
| 8 | | 8 | 300 ms | 10⁻⁶ | Video (Buffered Streaming), |
| 9 | | 9 | | | TCP-based (e.g., www, |
| | | | | | e-mail, chat, ftp, p2p |
| | | | | | file sharing, progressive |
| | | | | | video, etc.) |

The resource type indicated in table 1 determines if dedicated network resources related to a service are permanently allocated or not. In case of “GBR” resource type dedicated network resources related to a guaranteed bit rate (GBR) value, i.e. the bit rate that can be expected to be provided by a GBR bearer, are permanently allocated at bearer establishment/modification. In case of “Non-GBR” resource type no dedicated network resources are permanently allocated at bearer establishment/modification. According to one embodiment, a dedicated bearer can either be a GBR or a Non-GBR bearer while a default bearer can be only a Non-GBR bearer. According to one embodiment, every QCI (GBR and Non-GBR) is associated with a priority level. Priority level 1 is the highest priority level, and priority level 9 is the lowest priority level. The purpose of the priority levels is to allow, e.g. the base station 103, to appropriately schedule between different data flows from one mobile terminal and between different data flows from different mobile terminals. The packet delay budget (PDB) defines an upper bound for the time that a packet may be delayed between the mobile terminal 105 and the core network 102. For a certain QCI the value of the PDB is the same in uplink and downlink. The purpose of the PDB is to support the configuration of scheduling and link layer functions (e.g. the setting of scheduling priority weights and HARQ target operating points). The Packet Error Loss Rate (PELR) defines an upper bound for the rate of data packets (e.g. IP packets) that have been processed by a sender on a link layer protocol (e.g. RLC) level but that are not successfully delivered by the corresponding receiver to the upper layer (e.g. PDCP). The purpose of the PELR is to allow for appropriate link layer protocol configurations (e.g. RLC and HARQ in E-UTRAN). For a certain QCI the value of the PELR is the same in uplink and downlink.

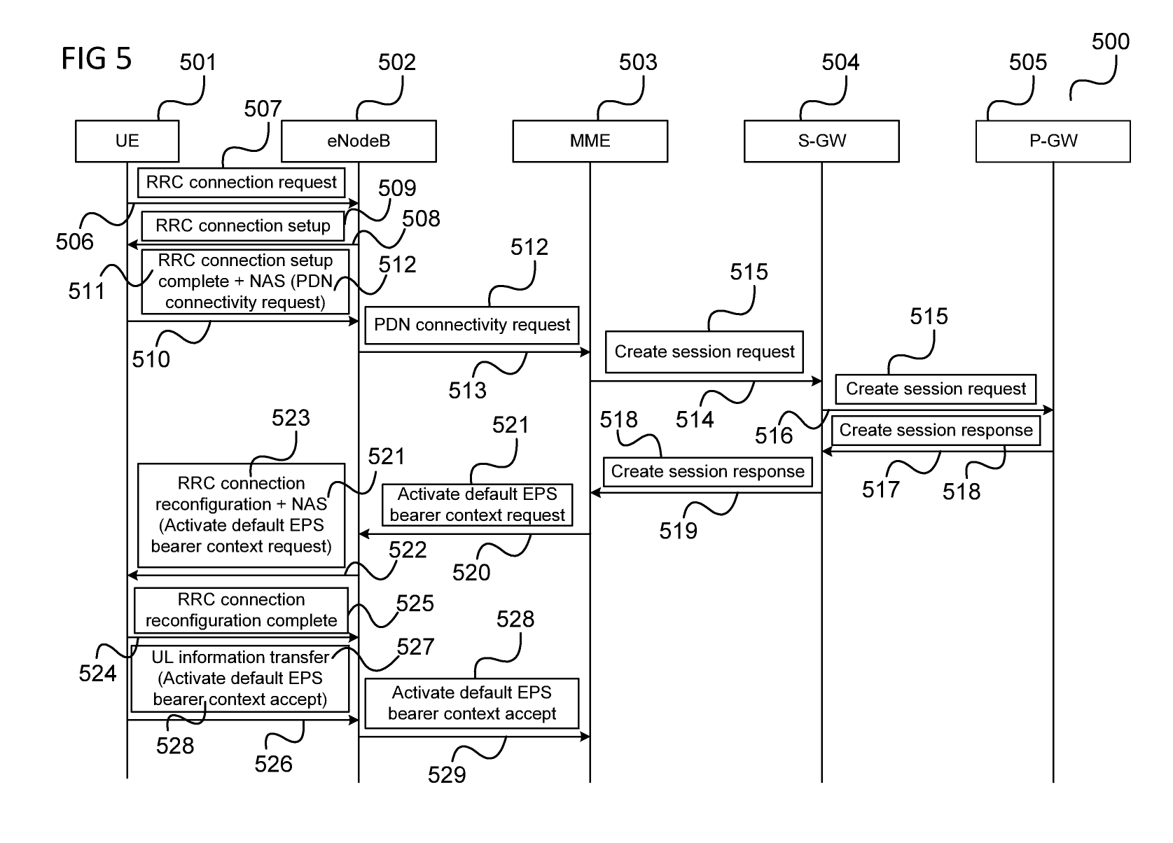

In the following, an exemplary default EPS bearer establishment procedure for a mobile terminal in RRC_IDLE state (e.g. the mobile terminal 105 in idle mode) for initiating the establishment of a communication service (“mobile originated data call”) with an external packet data network (PDN) such as the Internet 112 is described with reference to FIG. 5.

FIG. 5 shows a message flow diagram 500 according to an embodiment.

The message flow takes place between a mobile terminal 501 for example corresponding to mobile terminal 105, a base station 502 for example corresponding to the base station 103 operating the radio cell 104 in which the mobile terminal 501 is located, an MME 503 for example corresponding to MME 109, an S-GW 504 for example corresponding to the S-GW 110 and a P-GW 505 for example corresponding to the P-GW 111.

As result of the procedure illustrated in FIG. 5 a default EPS bearer and a data radio bearer associated with certain QoS attributes (corresponding to non-GBR resource type) are established in the mobile terminal 501 and the communication network (including the radio access network with base station 502 and the core network including MME 503, S-GW 504 and P-GW 505), the mobile terminal 501 is assigned an IP address so that it can communicate with the PDN (e.g. the Internet), and the access stratum protocol layers 1 to 3 are configured accordingly, so that the communication service can be provided in RRC_CONNECTED state at the QoS for the duration of the communication connection.

In detail, the default EPS bearer establishment procedure includes the following.

In 506, as an RRC connection needs to be established for the communication service, the mobile terminal 501 sends an RRC connection request message 507 to the base station 502 including as establishment cause “mobile originated data call”.

In 508, the base station 502 accepts the request and sends an RRC connection setup message 509 to the mobile terminal 501 with the configuration of the dedicated radio resources to establish the signaling radio bearer 1 (SRB1) that is used for RRC messages (which may include a piggybacked NAS message) as well as for NAS messages, all using DCCH logical channel.

In 510, the mobile terminal 501 sends to the base station 502 an RRC connection setup complete message 511 to confirm the successful completion of the RRC connection establishment. Along with the RRC connection setup complete message 511 the mobile terminal 501 sends, within the information element DedicatedInfoNAS, an NAS PDN connectivity request message 512 to the communication network (i.e. to the base station 502) to initiate establishment of a PDN connection.

In 513, upon reception of the RRC connection setup complete message 511 along with the NAS PDN connectivity request message 512, the base station 502 extracts the NAS PDN connectivity request message 512 and passes it to the MME 503.

In 514, the MME receives the PDN connectivity request message 512 and allocates a default EPS bearer QoS (i.e. a QCI and the maximum bit rate for uplink and downlink) and EPS bearer identity (e.g. a four bit value as unique identifier of the EPS bearer) for the default EPS bearer associated with the mobile terminal 501. Then it creates a create session request message 515 (including the IMSI (International Mobile Subscriber Identity) of the mobile terminal 501, the MSISDN (Mobile Subscriber Integrated Services Digital Network) number of the mobile terminal 501, the default EPS bearer QoS, and the EPS bearer identity), and sends the create session request message 515 to the S-GW 504.

In 516, the S-GW 504 forwards the Create session request message 515 to the P-GW 505.

In 517, the P-GW 505 stores the received parameters and responds with a Create session response message 518 including the IP address assigned to the mobile terminal 501.

In 519, the S-GW 504 forwards the Create session response message 518 to the MME 503.

In 520, the MME 503 receives the Create session response message 518. As result it creates an activate default EPS bearer context request message 521 (including EPS bearer QoS, EPS bearer identity, and IP address allocated to the mobile terminal 501) and sends it to the mobile terminal 501 via base station 502 to request activation of the default EPS bearer context.

In 522, the base station 502 forwards the activate default EPS bearer context request message 521 to the mobile terminal 501 via SRB1 mapped on the DCCH. Along with the activate default EPS bearer context request message 521 (which is an NAS message) the base station 502 sends an RRC connection reconfiguration message 523 including the dedicated radio resource configuration of the data radio bearer and the MAC layer and PHY layer configuration according to the assigned QoS attributes.

In 524, the mobile terminal 501 responds with an RRC connection reconfiguration complete message 525 to confirm the successful completion of an RRC connection reconfiguration.

In 526, after processing of the received activate default EPS bearer context request message 521 the mobile terminal 501 sends an UL information transfer message 527 to transmit an activate default EPS bearer context accept message 528 (which is a NAS message) to the communication network (i.e. to the base station 502). With the activate default EPS bearer context accept message 528 the mobile terminal 501 acknowledges activation of the default EPS bearer context.

In 529, the base station 502 extracts the activate default EPS bearer context accept message 528 from the UL information transfer message 527 and passes it to the MME 503. At this point the default EPS bearer and data radio bearer are established, so that mobile terminal 501 can start transmitting its data.

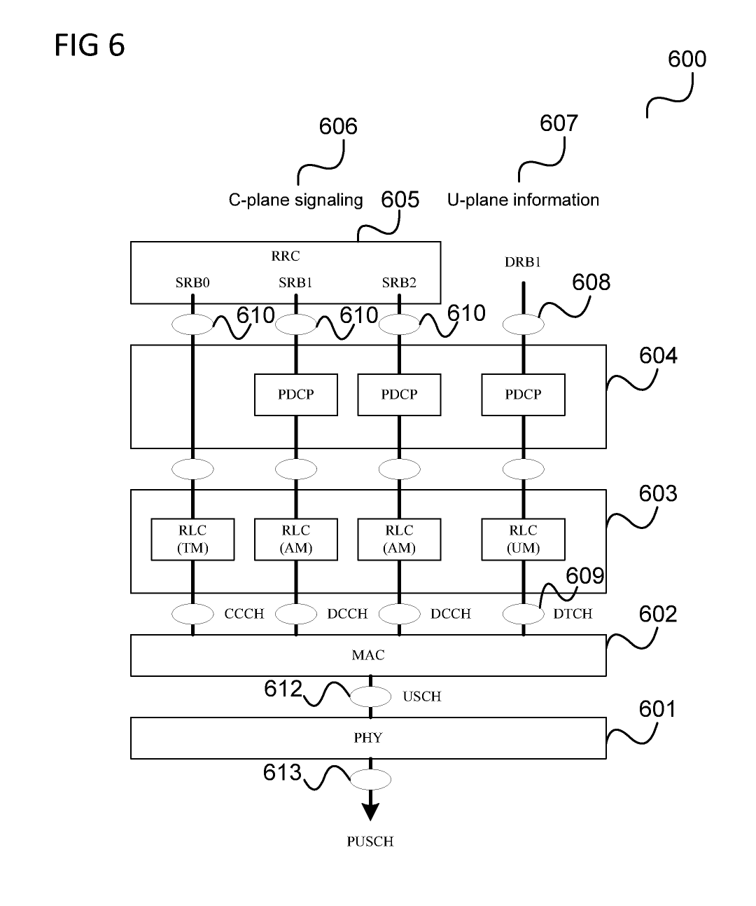

The radio protocol architecture configuration for the uplink resulting from the procedure illustrated in FIG. 5 is illustrated in FIG. 6.

FIG. 6 shows a protocol structure 600 according to an embodiment.

Similarly to the protocol structure 300 described with reference to FIG. 3, the protocol structure 600 includes physical layer 601, MAC layer 602, RLC layer 603, PDCP layer 604, and RRC layer 605 and may also be vertically divided into a C-plane 606 and a U-plane 607.

In the U-plane 607 the communication service is mapped to a data radio bearer DRB1 608 using DTCH logical channel 609. In the C-plane three SRBs 610 are configured:
SRB0 is for RRC messages using the CCCH logical channel;
SRB1 is for RRC messages (which may include a piggybacked NAS message) as well as for NAS messages prior to the establishment of SRB2, all using DCCH logical channel;
SRB2 is for NAS messages, using DCCH logical channel. SRB2 has a lower-priority than SRB1 and is configured by the radio access network 101 after security activation.

Except of SRB0 all other signaling and data radio bearers are associated with one PDCP entity as no PDCP functionality is required for SRB0. The physical layer 601 provides its services to the MAC layer 602 via the USCH transport channel 612 that is mapped to the PUSCH physical channel 613 on which the data from USCH 612 is transmitted over the Uu air interface 106 to the base station 103.

With regard to the continuously rising number of mobile subscribers worldwide there is a growing demand for mobile services, especially for packet-switched data services. To meet this demand and to provide its user access to wide range of services and applications easily, a mobile terminal may according to one embodiment support multiple radio access technologies (RATs), e.g. radio access technologies according to 3G UMTS, 2G GSM, WLAN and Bluetooth. From the communication network operator's perspective there is the challenging demand to provide enhanced coverage, capacity and cell-edge throughput at reasonable cost.

Heterogeneous and multi-RAT networks represent a disruptive approach to meet this challenging demand wherein enhanced coverage, capacity and cell-edge throughput is provided by different types of cells (e.g. macro cells, pico, femto) and RATs (e.g. LTE, UMTS, GSM, WLAN, Bluetooth). A basic idea of heterogeneous and multi-RAT networks can be seen in offloading traffic from a macro radio cell operated in a first (e.g. licensed, expensive) frequency spectrum and according to a first radio access technology to a small area radio cell within the macro radio cell operated in a second (e.g. unlicensed, inexpensive) frequency spectrum and according to a second radio access technology.

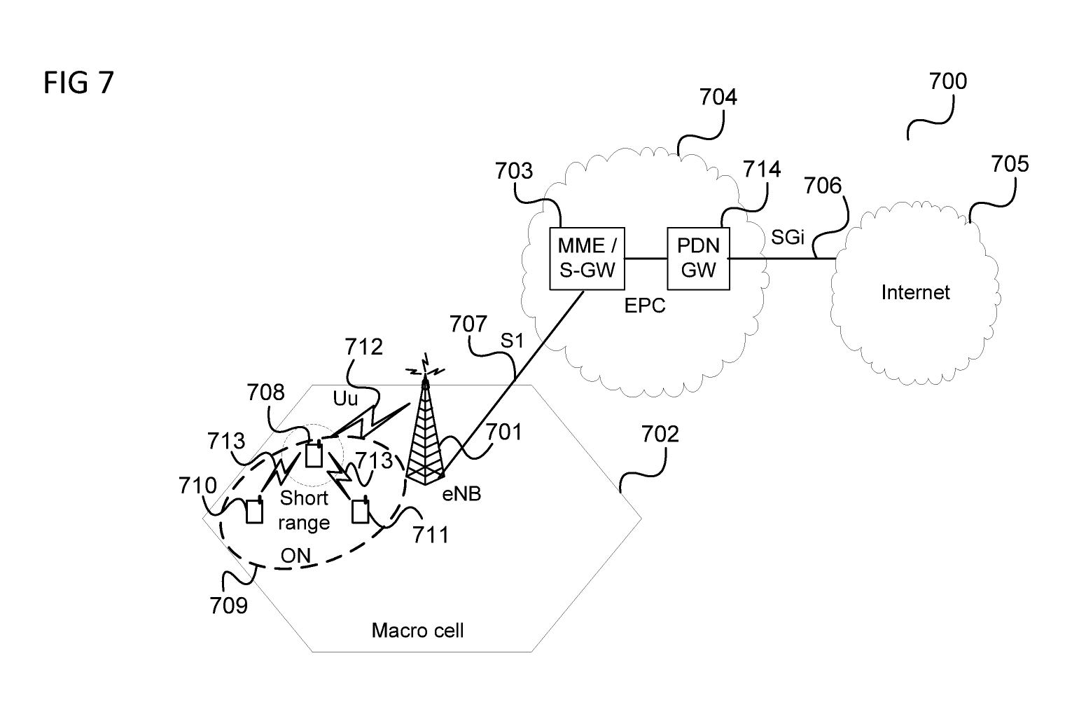

An example for a heterogeneous network deployment scenario using two different radio access technologies is illustrated in FIG. 7.

FIG. 7 shows a communication system 700 according to an embodiment.

The communication system 700 includes, similarly to the communication system 100 described above with reference to FIG. 1, a base station 701 operating a (macro) radio cell 702, a core network 704 including an MME/S-GW 703 (i.e. an MME, an S-GW, or a component including both functionalities) and a PDN-GW 714 connecting the core network 704 to the Internet 705 via an SGi interface 706. The base station 701 is part of a radio access network (according to LTE in this example) and is connected to the core network 704 via an S1 interface 707.

The base station 701 provides macro cell coverage as an LTE eNB and operates in a licensed spectrum (i.e. licensed by the operator of the radio access network and the core network 704). A first mobile terminal 708 is located in the mobile radio cell 702. The first mobile terminal 708 is a dual-RAT LTE relaying mobile terminal using short-range RAT such as, e.g. WLAN or Bluetooth and operated in unlicensed spectrum, e.g. the ISM (Industrial Scientific Medical) band, and provides additional small area coverage for an opportunistic network 709. The opportunistic network 709 includes a second mobile terminal 710 and a third mobile terminal 711.

The opportunistic network 709 is operated using a RAT different from LTE, and may be dynamically established and controlled by the cellular communication network (including the radio access network and the core network 704) whenever and wherever it is needed and possible to deliver mobile services to mobile subscribers at reasonable cost. In the opportunistic network 709, the ON terminals (i.e. the second mobile terminal and the third mobile terminal) 710, 711 are connected via air interfaces 713 (e.g. according to WLAN or Bluetooth) to the relaying mobile terminal (i.e. the first mobile terminal) 708, and the relaying mobile terminal 708 itself is connected to the base station 701 (and thus to the cellular communication network) via an LTE Uu air interface 712.

Access to mobile services for the ON terminals 710, 711 is maintained by the relaying mobile terminal 708. This means that from the perspective of the ON terminals 710, 711 the relaying mobile terminal 708 can be considered as a network node (e.g. a mobile hotspot) routing the data that are exchanged between the ON terminals 710, 711 and the cellular communication network.

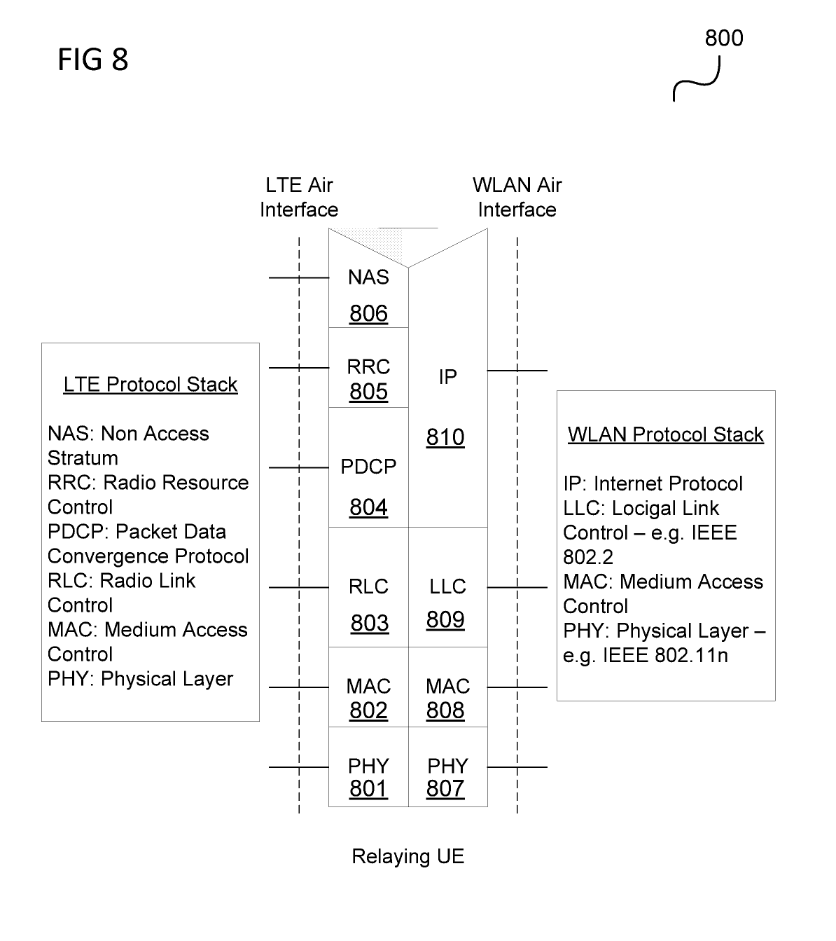

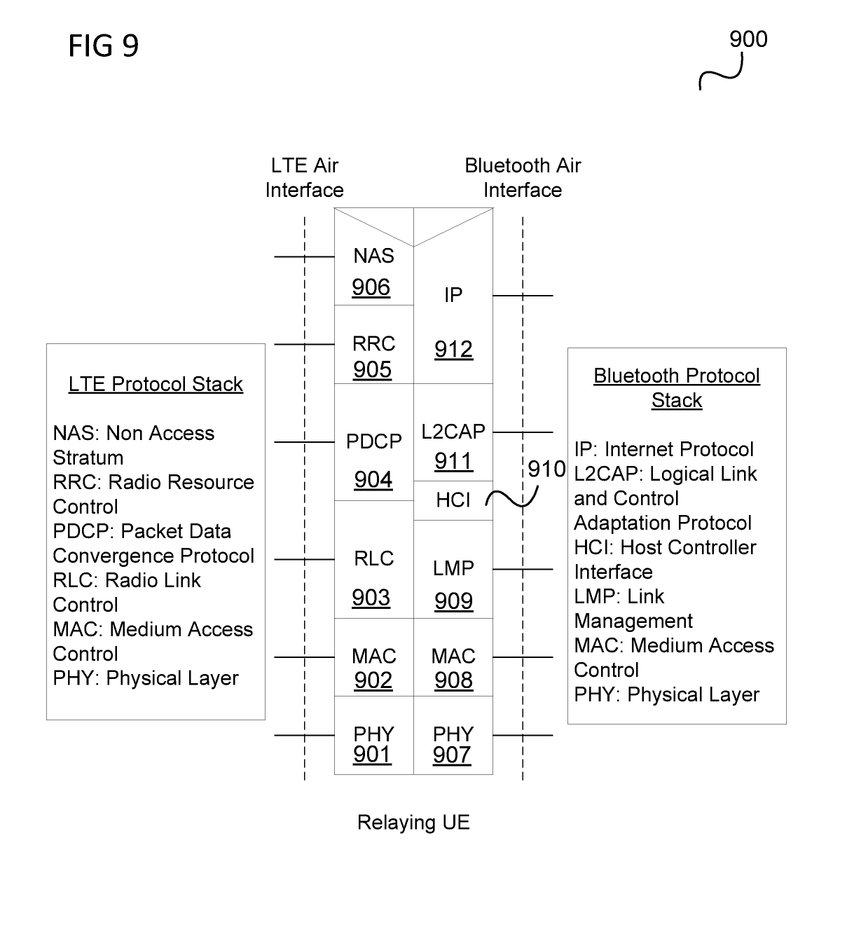

In addition, the relaying mobile terminal 708 itself may also access mobile services. Thus, from protocol architecture point of view the relaying mobile terminal 708 has to support (at least) two protocol stacks. This is illustrated in FIGS. 8 and 9.

FIG. 8 shows a protocol stack architecture 800 according to an embodiment.

The protocol stack architecture 800 is used in case the opportunistic network 709 is operated using WLAN.

The protocol stack architecture 800 includes, for the LTE air interface 712, a first physical layer 801, a first MAC layer 802, an RLC layer 803, a PDCP layer 804, an RRC layer 805, and an NAS layer 806. For the air interfaces 713 (in this example WLAN air interfaces) to the ON terminals 710, 711, the protocol stack architecture 800 includes a second physical layer 807, a second MAC layer 808, an LLC layer 809, and an IP layer 810.

FIG. 9 shows a protocol stack architecture 900 according to an embodiment.

The protocol stack architecture 900 is used in case the opportunistic network 709 is operated using Bluetooth.

The protocol stack architecture 900 includes, for the LTE air interface 712, a first physical layer 901, a first MAC layer 902, an RLC layer 903, a PDCP layer 904, an RRC layer 905, and an NAS layer 906. For air interfaces 713 (in this example Bluetooth air interfaces) to the ON terminals 710, 711, the protocol stack architecture 900 includes a second physical layer 907, a second MAC layer 908, an LMP (Link Management) layer 909, a HCI (Host Controller Interface) layer 910, an L2CAP (Logical Link and Control Adaptation Protocol) layer 911, and an IP layer 912.

WLAN (standard for wireless LAN connectivity) according to IEEE 802.11b or 802.11g and Bluetooth (standard for short-range connectivity) can be operated in the license-free ISM band (2.4-2.4835 GHz). Both systems use TDD as duplexing scheme. In WLAN the ISM band is separated into three non-overlapping radio frequency (RF) channels of 22 MHz bandwidth each, and one specific RF channel is used for data transmission between a WLAN device and an access point (in this example one of the ON terminals 710, 711 and the relaying terminal 708). In Bluetooth the ISM band is separated into 79 RF channels of 1 MHz bandwidth each beginning at 2.402 GHz. For data transmission between two Bluetooth devices all 79 RF channels are used according to a frequency hopping scheme. Further, in order to minimize interference to WLAN when Bluetooth and WLAN are operated simultaneously in the ISM band data transmission between two Bluetooth devices can be performed according to an adaptive frequency hopping scheme, wherein particular RF channels are avoided that are currently used by a WLAN.

The concept of heterogeneous and multi-RAT networks such as the communication system 700 is currently not specified in LTE. For a standardized solution in LTE there are many aspects. One aspect not yet specified in LTE concerns the establishment and maintenance of the EPS bearer contexts for the ON terminals 710, 711 that are connected to the core network 704 through the relaying terminal 708. As described above, an EPS bearer is used for using a communication service.

One approach may be that the EPS bearer contexts for ON terminals 710, 711 are associated to the existing EPS bearer context(s) of the relaying mobile terminal 708. Such an approach is feasible but exhibits the drawbacks that a differentiated QoS and charging control for the relaying mobile terminal 708 and the ON terminals 710, 711 may not be possible when using this approach.

According to one embodiment, a solution for establishment and maintenance of EPS bearer contexts for ON terminals is proposed that allows a differentiated QoS and charging control in heterogeneous and multi-RAT network deployments.

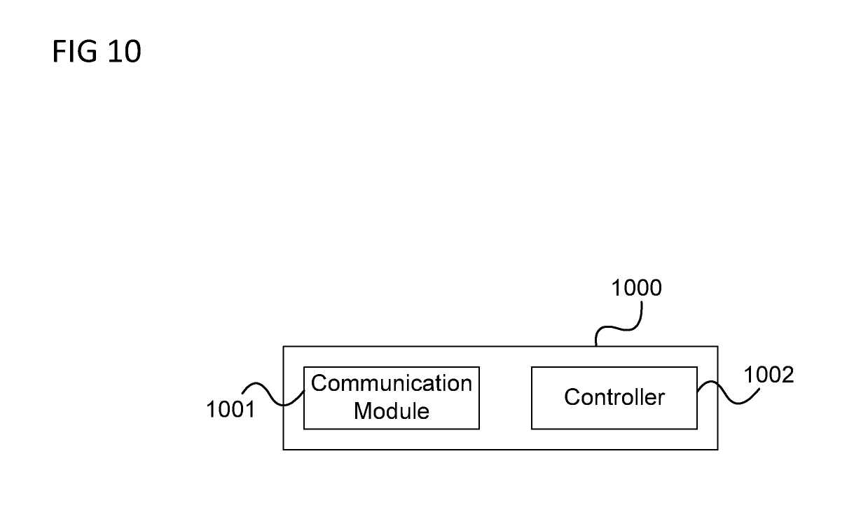

FIG. 10 shows a communication terminal 1000 according to an embodiment.

The communication terminal 1000 includes a communication module 1001 configured to establish an NAS bearer connection between the communication terminal and a core network of a cellular mobile communication network.

The communication terminal 1000 further includes a controller 1002 configured to control the communication terminal to dedicatedly use the NAS bearer connection to exchange data between at least one second communication terminal (the communication terminal 1000 for example being a first communication terminal) communicating with the communication terminal and the core network.

In one embodiment, in other words, a communication terminal operating as a relay communication device of a mobile communication network establishes a communication connection on NAS level (i.e. on a higher layer than access stratum (AS) level, in other words on a layer above the AS protocols) to the core network of the mobile communication network which it uses only for relaying data and, for example, does not use for data used by itself, e.g. useful data processed or to be processed by itself or data (including useful data and/or control data) used for a communication service used by the communication terminal itself. In other words, the communication terminal keeps at least one communication connection to the core network to be used for the relaying and at least one communication connection to the core network used for other purposes, e.g. for the exchange of data between itself (i.e. non-relayed data e.g. generated or to be processed by itself) and the core network.

According to one embodiment the controller is configured to control the communication terminal to dedicatedly use the NAS bearer connection to exchange data only between the at least one second communication terminal and the core network.

According to one embodiment the controller is configured to control the communication terminal to dedicatedly use the NAS bearer connection to relay data between the at least one second communication terminal and the core network.

The communication terminal may be a mobile communication terminal, for example a subscriber terminal of the cellular mobile communication network.

According to one embodiment the NAS bearer connection is a communication connection provided by means of an EPS bearer.

According to one embodiment, the communication terminal is configured to communicate with the core network using a first radio access technology and using a first frequency band and is configured to communicate with the at least one second communication terminal using a second radio access technology and using a second frequency band.

The first radio access technology is for example different from the second radio access technology.

The first radio access technology may be a cellular mobile communication network radio access technology. For example, the first radio access technology is an LTE radio access technology.

The second radio access technology may be a local area network radio access technology. For example, the second radio access technology is a WLAN radio access technology.

The first frequency band may be different from the second frequency band.

The communication terminal may be configured to operate a radio cell using the second radio access technology and the second frequency band.

The communication terminal may further include a signaling circuit configured to signal to the cellular mobile communication network that the NAS bearer connection is to be associated with the at least one second communication terminal.

The signaling circuit may further be configured to signal to the cellular mobile communication network that the NAS bearer connection associated with the at least one second communication terminal is to be released.

According to one embodiment the controller is configured to control the communication terminal to exchange data between the at least one second communication terminal and the core network using the NAS bearer connection according to a quality of service associated with the NAS bearer connection.

According to one embodiment the communication module is configured to establish a further NAS bearer connection between the communication terminal and the core network.

According to one embodiment, the controller is configured to control the communication terminal to dedicatedly exchange data between a second communication terminal of the at least one second communication terminal and the core network using the NAS bearer connection and to dedicatedly exchange data between another communication terminal of the at least one second communication terminal and the core network using the further NAS bearer connection.

According to one embodiment the controller is configured to control the communication terminal to exchange data using the NAS bearer connection according to a quality of service associated with the further NAS bearer connection.

According to one embodiment the quality of service associated with the NAS bearer connection is different from the quality of service associated with the further NAS bearer connection.

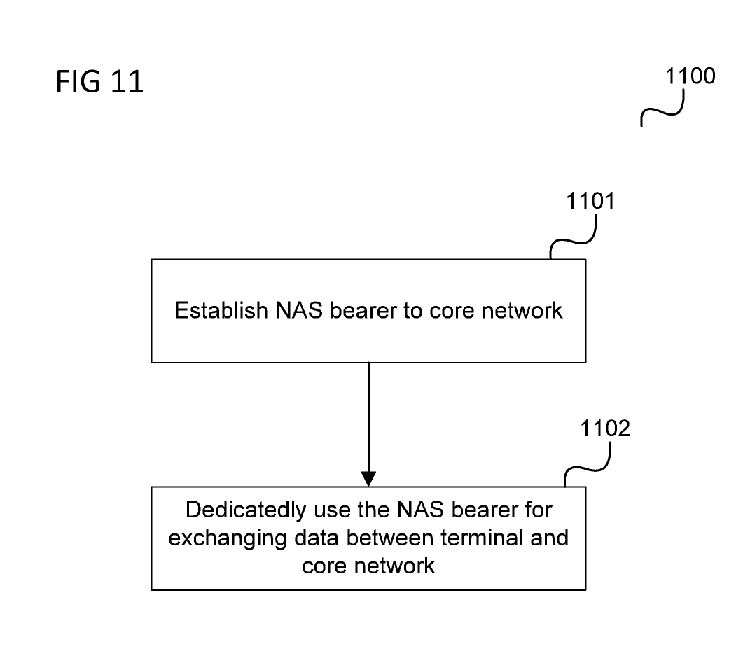

The communication terminal 1000 for example carries out a method as illustrated in FIG. 11.

FIG. 11 shows a flow diagram 1100 according to an embodiment.

The flow diagram 1100 illustrates a method for exchanging data.

In 1101, an NAS bearer connection between a communication terminal and a core network of a cellular mobile communication network is established.

In 1102, the communication terminal is controlled to dedicatedly use the NAS bearer connection to exchange data between at least one second communication terminal communicating with the communication terminal and the core network.

According to one embodiment, a communication device is provided including a receiver configured to receive a request from a first communication terminal to establish an NAS bearer connection between the first communication terminal and a core network of a cellular mobile communication network and to associate the NAS bearer connection with at least one second communication terminal communicating with the first communication terminal and a controller configured to establish an NAS bearer connection between the first communication terminal and the core network (e.g. in response to the request) and to associate the NAS bearer connection with the at least one second communication terminal (e.g. in response to the request).

The communication device may further include a radio module exchanging data with the at least one second communication terminal via the first communication terminal using the NAS bearer connection.

According to one embodiment, the receiver is further configured to receive a request to release the NAS bearer connection and the controller is configured to release the NAS bearer connection in response to the release request.

According to one embodiment, the communication device is a network entity of a cellular mobile communication network.

According to one embodiment, a method for establishing a communication connection is provided including receiving a request from a first communication terminal to establish an NAS bearer connection between the first communication terminal and a core network of a cellular mobile communication network and to associate the NAS bearer connection with at least one second communication terminal communicating with the first communication terminal, establishing an NAS bearer connection between the first communication terminal and the core network, and associating the NAS bearer connection with the at least one second communication terminal.

It should be noted that embodiments described in context of the communication terminal 1000 are analogously valid for the method for exchanging data illustrated in FIG. 11, the communication device and the method for establishing a communication connection and vice versa.

According to one embodiment, the communication terminal 1000 establishes and maintains EPS bearer contexts for ON terminals such that a differentiated QoS and charging control in heterogeneous and multi-RAT network deployments is allowed. This is described in the following with reference to the communication system 700 shown in FIG. 7.

According to one embodiment, the following NAS signaling is carried out in the communication system 700 for establishment and maintaining an EPS bearer for an ON terminal 710, 711.
A PDN connectivity association request message is sent by the relaying mobile terminal 708 to the mobile communication network to initiate establishment of a PDN connection for the ON terminal 710, 711 and to associate the PDN connection to the relaying terminal 708. In this message one or more identities of the ON terminal 710, 711 are included, such as the IMSI and/or the MSISDN.
A PDN connectivity release request message is sent by the relaying terminal 708 to the mobile communication network to release a PDN connection for an ON terminal 710, 711 associated to the relaying terminal 708. In this message one or more identities of the ON terminal 710, 711 are included, such as the IMSI and/or the MSISDN, as well as the EPS bearer identity and IP address to be released.
Further, the NAS messages Activate default EPS bearer context request (sent by the MME 703 to the relaying terminal 708), Activate default EPS bearer context accept (sent by the relaying terminal 708 to the MME 703), Deactivate EPS bearer context request (sent by the MME 703 to the relaying terminal 708), and Deactivate EPS bearer context accept (sent by the relaying terminal 708 to the MME 703) as described above with reference to FIG. 5 are according to one embodiment extended with an information element “ON terminal identity”. This information element is set when the default EPS bearer establishment or EPS bearer deactivation is performed for the ON terminal 710, 711 and not for the relaying terminal 708.

According to one embodiment, regarding the AS (Access Stratum) C-plane configuration an uplink RRC connection reconfiguration request message for establishing and modifying ON-specific data radio bearers is introduced. This message also contains an information element “DedicatedInfoNAS” to carry NAS messages. This message is sent by the relaying terminal 708 to the base station 701.

According to one embodiment, regarding the AS (Access Stratum) U-plane configuration
In the relaying terminal 708 the data radio bearers for ON terminals 710, 711 are established and maintained separately from the data radio bearers for the relaying terminal 708 itself.
An ON-specific data radio bearer is configured for an ON terminal 710, 711 or a group of ON terminals 710, 711 which use a communication service having the same QoS attributes. Each ON-specific data radio bearer is characterized by definite QoS attributes, such as maximum bit rate, RLC mode, and logical channel priority.

In the following, embodiments are described with reference to the communication system 700 shown in FIG. 7 wherein it is assumed that the mobile communication network is an LTE network based on OFDMA/TDMA in downlink, SC-FDMA/TDMA in uplink, and operates in FDD mode. Further, as described with reference to FIG. 7, the first mobile terminal 708 is assumed to be a dual-RAT relaying terminal and the second mobile terminal 710 and third mobile terminal 711 are ON terminals (communicating with the relaying terminal 708 via a short range radio technology and are thus part of the opportunistic network 709 operated by the relaying terminal 709) and are located in the LTE macro radio cell 702 operated by the base station 701.

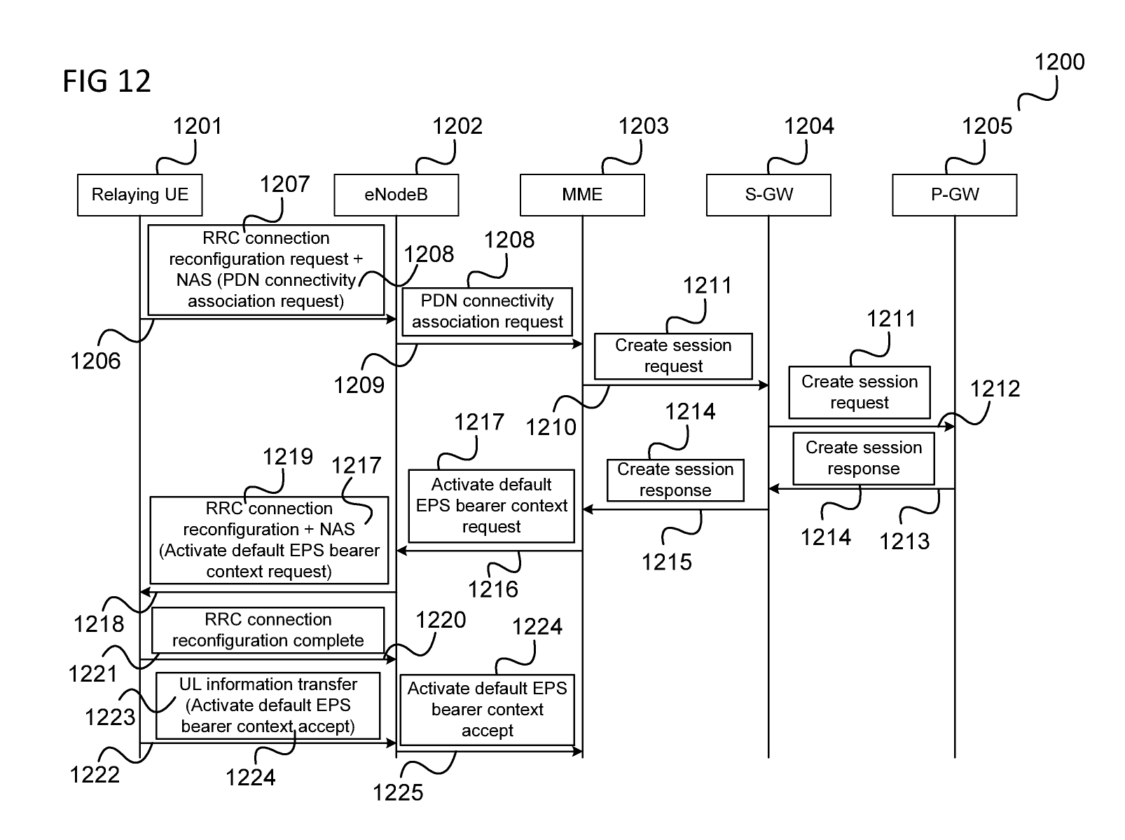

An example for an EPS bearer activation according to one embodiment is described in the following with reference to FIG. 12.

FIG. 12 shows a message flow diagram 1200 according to an embodiment.

The message flow takes place between a relaying terminal 1201 corresponding to the relaying terminal 708, a base station 1202 corresponding to the base station 701 operating the radio cell 104 in which the mobile terminal 501 is located, an MME 1203 and an S-GW 1204, e.g. corresponding to the MME/S-GW 703, and a P-GW 1205 corresponding to the PDN-GW 714.

It is assumed that the relaying terminal 1201 is in RRC_CONNECTED state and is using two communication services with an external packet data network, e.g. the Internet 705. Further, as mobile hotspot the relaying terminal 1201 provides connectivity to the Internet 705 using WLAN to the ON terminals 710, 711. It is assumed that the ON terminals 710, 711 connect as WLAN clients to the relaying terminal 1201 to get access to Internet services. As result, the opportunistic network 709 is set up by the relaying terminal 1201 and a default EPS bearer establishment procedure is performed for the two ON terminals 710, 711 (also referred to as WLAN client #1 and WLAN client #2) as follows.

In 1206, after the relaying terminal 1201 received the connection requests for accessing the communication services from the two ON terminals 710, 711 it sends to the base station 1202 an RRC connection reconfiguration request message 1207 to request the establishment of ON-specific data radio bearers.

Along with the RRC connection reconfiguration request message 1207 the relaying terminal 1201 sends within the information element “DedicatedInfoNAS” a PDN connectivity association request message 1208 (which is an NAS message) to the base station 1202 to initiate establishment of a PDN connection for the two ON terminals 710, 711 and to associate the PDN connections to the relaying terminal 1201. In the PDN connectivity association request message 1208 the identities of the ON terminals 710, 711 (e.g. the IMSI and/or MSISDN of each ON terminal 710, 711) are included.

In 1209, upon reception of the RRC connection reconfiguration request message 1207 along with the PDN connectivity association request message 1208, the base station 1202 extracts the PDN connectivity association request message 1208 and passes it to the MME 1203.

In 1210, the MME 1203 receives the PDN connectivity association request message 1208 and allocates for each ON terminal the default EPS bearer QoS (e.g. a QCI and a maximum bit rate for uplink and downlink) and EPS bearer identity (e.g. a four bit value as unique identifier of the EPS bearer). Then it creates a create session request message 1211 (including the IMSIs and/or MSISDNs of the ON terminals 710, 711, the default EPS bearer QoS, and the EPS bearer identity), and sends the create session request message 1211 to the S-GW 1204.

In 1212, the S-GW 1204 forwards the create session request message 1211 to the P-GW 1205.

In 1213, the P-GW 1205 stores the received parameters and responds with a create session response message 1214 including the IP address assigned to each ON terminal 710, 711.

In 1215, the S-GW 1204 forwards the create session response message 1214 to the MME 1203.

The MME 1203 receives the create session response message 1214. In 1216, as result, it creates an activate default EPS bearer context request message 1217 (including the EPS bearer QoS, the EPS bearer identity, and the IP addresses for each ON terminal) and sends it to the relaying terminal 1201 via the base station 1202 to request activation of the default EPS bearer context for each ON terminal 710, 711.

In 1218, the base station 1202 forwards the activate default EPS bearer context request message 1217 to the relaying terminal 1201 via SRB1 mapped on DCCH. Along with the activate default EPS bearer context request message 1217 the base station 1202 sends an RRC connection reconfiguration message 1219 including the dedicated radio resource configuration of data radio bearers according to the assigned QoS attributes for each ON terminal 710, 711. In this example, two data radio bearers are configured by the base station 1202 as the ON terminals 710, 711 are using two different services of QCI resource type Non-GBR.

In 1220, the mobile terminal 1201 responds with an RRC connection reconfiguration complete message 1221 to confirm the successful completion of the RRC connection reconfiguration.

In 1222, after processing of the received activate default EPS bearer context request message 1217 the relaying terminal 1201 sends an uplink information transfer message 1223 to transmit an activate default EPS bearer context accept message 1224 (which is an NAS message) to the communication network (specifically the base station 1202). With the activate default EPS bearer context accept message 1224 the relaying terminal 1201 acknowledges activation of the default EPS bearer context for the two ON terminals 710, 711.

In 1225, the base station 1202 extracts the activate default EPS bearer context accept message 1224 from the uplink information transfer message 1223 and passes it to the MME 1203. At this point the default EPS bearer and data radio bearer for the two ON terminals 710, 711 are established in the communication network and associated to the relaying terminal 1201, so that both ON terminals 710, 711 can start transmitting their data to the communication network through the relaying terminal 1201.

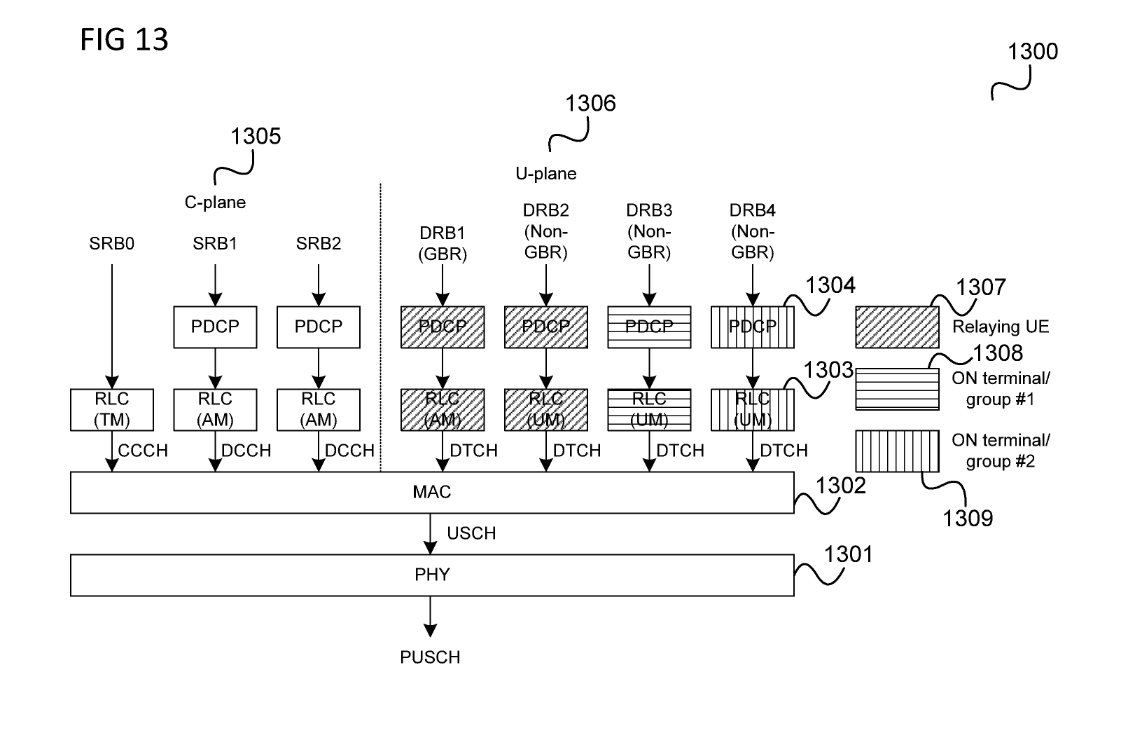

The radio protocol architecture resulting from the procedure illustrated in FIG. 12 in the relaying terminal 708 for the uplink is illustrated in FIG. 13.

FIG. 13 shows a protocol architecture 1300 according to an embodiment.

The protocol architecture 1300 includes a physical layer 1301, a MAC layer 1302, RLC entities 1303 of the RLC layer, and PDCP entities 1304 of the PDCP layer. The protocol architecture 1300 may be divided into a C-plane 1305 and a U-plane 1306.

In the U-plane 1306, overall four data radio bearers are configured: DRB1 and DRB2 for the relaying terminal 708 itself, DRB3 for the second mobile terminal (ON terminal #1) 710 and DRB4 for the third mobile terminal (ON terminal #2) 711. A first hatching 1307 indicates the PDCP entities and RLC entities for handling data of the relaying terminal 708, a second hatching 1308 indicates the PDCP entity and the RLC entity for handling data of the second mobile terminal 710, and a third hatching 1309 indicates the PDCP entity and the RLC entity for handling data of the third mobile terminal 711.

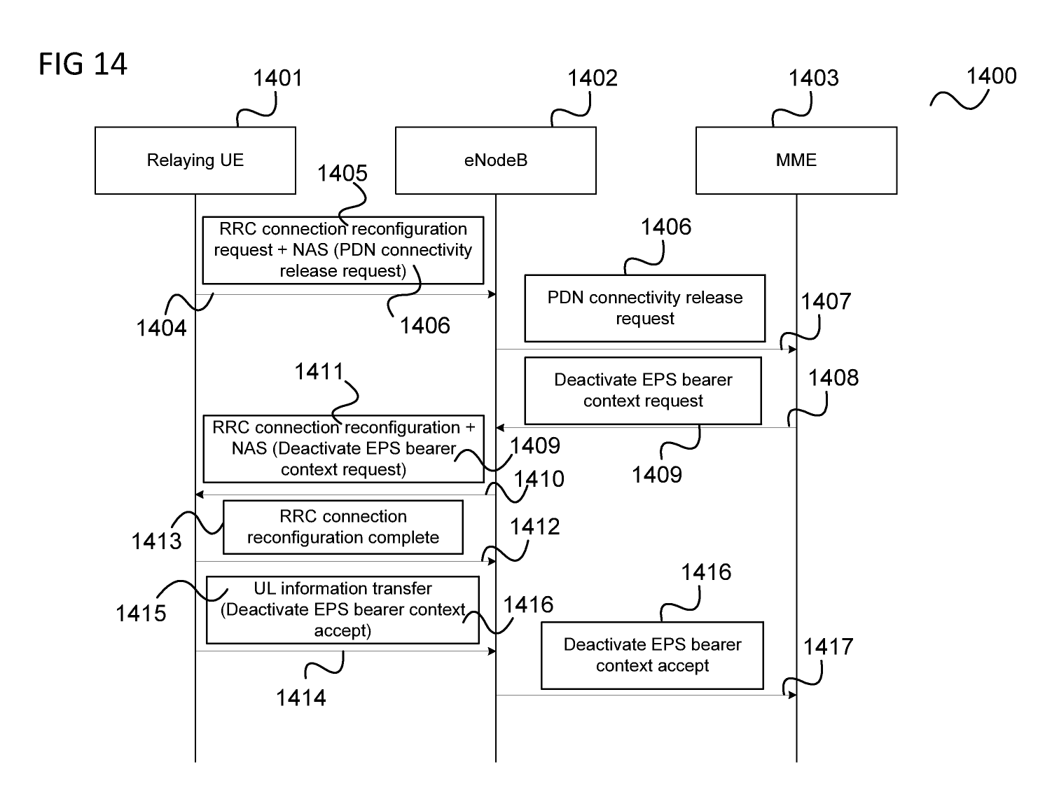

In the following, an example is described in which the third mobile terminal (ON terminal #2; WLAN client #2) 711 ends its communication service, so that its established default EPS bearer needs to be deactivated, i.e. released. The corresponding EPS bearer deactivation procedure is illustrated in FIG. 14.

FIG. 14 shows a message flow diagram 1400 according to an embodiment.

The signaling flow takes place between a relaying terminal 1401 corresponding to the relaying terminal 708, a base station 1402 corresponding to the base station 701, and an MME 1403 corresponding to the MME/S-GW 703.

In 1404, the relaying terminal 1401 sends to the base station 1402 an RRC connection reconfiguration request message 1405 to request the reconfiguration of ON-specific data radio bearers, i.e. to release the DRB4 that was configured for third mobile terminal 711 (see FIG. 13).

Along with the RRC connection reconfiguration request message 1405 the relaying terminal 1401 sends within the information element “DedicatedInfoNAS” an PDN connectivity release request message 1406 (which is an NAS message) to the communication network (specifically to base station 1402) to initiate deactivation of the PDN connection for the third mobile terminal 711. In the PDN connectivity release request message 1406 the identities of the third mobile terminal 711 (e.g. the IMSI and/or the MSISDN) as well as the EPS bearer identity and the IP address of the third mobile terminal 711 are included.

In 1407, upon reception of the RRC connection reconfiguration request message 1405 along with the PDN connectivity release request message 1406, the base station 1402 extracts the PDN connectivity release request message 1406 and passes it to MME 1403.

In 1408, the MME 1403 receives the PDN connectivity release request message 1406. After processing it creates a deactivate EPS bearer context request message 1409 to request the deactivation of the indicated default EPS bearer for the third mobile terminal 711 and sends the deactivate EPS bearer context request message 1409 to the relaying terminal 1401. In this context the MME 1403 also creates and sends the corresponding message to the PDN-GW 714 to deactivate the respective PDN connection and to release the IP address assigned to the third mobile terminal 711.

In 1410, the base station 1402 forwards the deactivate EPS bearer context request message 1409 to the relaying terminal 1401 via SRB1 mapped on DCCH. Along with the deactivate EPS bearer context request message 1409 the base station 1402 sends an RRC connection reconfiguration message 1411 to release DRB4 that was configured for the third mobile terminal 711.

In 1412, the relaying terminal 1401 responds with an RRC connection reconfiguration complete message 1413 to confirm the successful completion of the RRC connection reconfiguration.

In 1414, after processing of the received deactivate EPS bearer context request message 1409 the relaying terminal 1401 sends an uplink information transfer message 1415 to transmit a deactivate EPS bearer context accept message 1416 (which is an NAS message) to the communication network. With the deactivate EPS bearer context accept message 1416 the relaying terminal 1401 acknowledges deactivation of the EPS bearer context for the third mobile terminal 711.

In 1417, the base station 1402 extracts the deactivate EPS bearer context accept message 1416 from the uplink information transfer message 1415 and passes it to the MME 1403. At this point, the EPS bearer and data radio bearer for the third mobile terminal 711 are deactivated/released in the communication network.

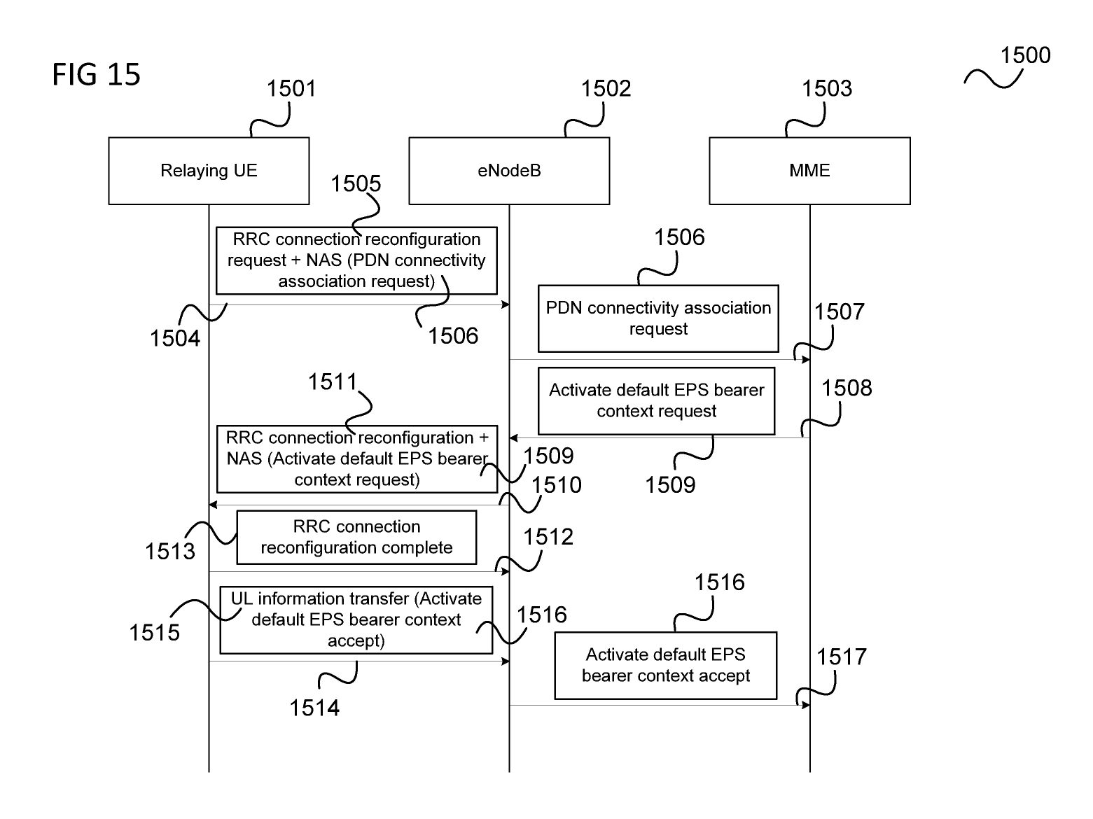

In the following, an example is given for the case in which existing EPS bearer contexts for the second mobile terminal 710 and the third mobile terminal 711 are re-associated to the relaying mobile terminal 708. This may for example be done when the second mobile terminal 710 and the third mobile terminal 711 are dual-RAT terminals (e.g. equipped with both an LTE and a WLAN modem) and have started their communication services in the LTE macro cell 702 using their LTE modems and for example due to shortage of radio resources in the macro cell 702 the communication network has decided to offload traffic from the second mobile terminal 710 and the third mobile terminal 711 to the relaying terminal 708 (i.e. to have the second mobile terminal 710 and the third mobile terminal 711 communicate via the relaying terminal 708 with the radio access network). The corresponding EPS bearer re-association procedure for the second mobile terminal 710 and the third mobile terminal 711 is illustrated in FIG. 15.

FIG. 15 shows a message flow diagram 1500 according to an embodiment.

The signaling flow takes place between a relaying terminal 1501 corresponding to the relaying terminal 708, a base station 1502 corresponding to the base station 701, and an MME 1503 corresponding to the MME/S-GW 703.

In 1504, the relaying terminal 1501 sends to the base station 1502 an RRC connection reconfiguration request message 1505 to request the reconfiguration of ON-specific data radio bearers.

Along with the RRC connection reconfiguration request message 1505 the relaying terminal 1501 sends within the information element “DedicatedInfoNAS” a PDN connectivity association request message (which is an NAS message) 1506 to the communication network (specifically to base station 1502) to initiate re-association of existing PDN connections for the second mobile terminal 710 and the third mobile terminal 711 to the relaying terminal 1501. In the PDN connectivity association request message 1506 the identities of the second mobile terminal 710 and the third mobile terminal 711 (e.g. the IMSI and/or the MSISDN) as well as the EPS bearer identity and the IP address of the second mobile terminal 710 and the third mobile terminal 711 are included.

In 1507, upon reception of the RRC connection reconfiguration request message 1505 along with the PDN connectivity association request message 1506, the base station 1502 extracts the PDN connectivity association request message 1506 and passes it to MME 1503.

In 1508, the MME 1503 performs the re-association of the existing PDN connections for the second mobile terminal 710 and the third mobile terminal 711 to the relaying terminal 1501 and creates an activate default EPS bearer context request message 1509 and sends the activate default EPS bearer context request message 1509 to the relaying terminal 1501 via the base station 1502 to request activation of the default EPS bearer context for the second mobile terminal 710 and the third mobile terminal 711.

In 1510, the base station 1502 forwards the activate default EPS bearer context request message 1509 to the relaying terminal 1501 via SRB1 mapped on DCCH. Along with the activate default EPS bearer context request message 1509 the base station 1502 sends an RRC connection reconfiguration message 1511 including the dedicated radio resource configuration of data radio bearers according to the assigned QoS attributes for the second mobile terminal 710 and the third mobile terminal 711. Two data radio bearers are configured by the base station 1502 as the second mobile terminal 710 and the third mobile terminal 711 are using two different services of QCI resource type “Non-GBR”.

In 1512, the relaying terminal 1501 responds with an RRC connection reconfiguration complete message 1513 to confirm the successful completion of the RRC connection reconfiguration.

In 1514, after processing of the received activate default EPS bearer context request message 1509 the relaying terminal 1501 sends an uplink information transfer message 1515 to transmit an activate default EPS bearer context accept message 1516 (which is an NAS message) to the communication network. With the activate default EPS bearer context accept message 1516 the relaying terminal 1501 acknowledges activation of the default EPS bearer context for the second mobile terminal 710 and the third mobile terminal 711.

In 1517, the base station 1502 extracts the activate default EPS bearer context accept message 1516 from the uplink information transfer message 1515 and passes it to the MME 1503. At this point, the default EPS bearer and data radio bearer for the second mobile terminal 710 and the third mobile terminal 711 are re-associated to the relaying terminal 1501, so that both mobile terminals 710, 711 can start transmitting their data to the communication network through the relaying terminal 1501.

The resulting radio protocol architecture in the relaying terminal 1501 for the uplink is the same as the one resulting from the procedure illustrated in FIG. 12, i.e. the radio protocol architecture illustrated in FIG. 13. Specifically, as explained above, in the U-plane 1306 overall four data radio bearers are configured: DRB1 and DRB2 for the relaying terminal 1501 itself, DRB3 for the second mobile terminal 710 and DRB4 for the third mobile terminal 711.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A communication terminal comprising
a communication module configured to establish an NAS bearer connection between the communication terminal and a core network of a cellular mobile communication network;
a controller configured to control the communication terminal to dedicatedly use the NAS bearer connection to exchange data between at least one second communication terminal communicating with the communication terminal and the core network.

2. The communication terminal according to claim 1, wherein the controller is configured to control the communication terminal to dedicatedly use the NAS bearer connection to exchange data only between the at least one second communication terminal and the core network.

3. The communication terminal according to claim 1, wherein the controller is configured to control the communication terminal to dedicatedly use the NAS bearer connection to relay data between the at least one second communication terminal and the core network.

4. The communication terminal according to claim 1, being a mobile communication terminal.

5. The communication terminal according to claim 4, being a subscriber terminal of the cellular mobile communication network.

6. The communication terminal according to claim 1, wherein the NAS bearer connection is a communication connection provided by means of an EPS bearer.

7. The communication terminal according to claim 1, wherein the communication terminal is configured to communicate with the core network using a first radio access technology and using a first frequency band and is configured to communicate with the at least one second communication terminal using a second radio access technology and using a second frequency band.

8. The communication terminal according to claim 7, wherein the first radio access technology is different from the second radio access technology.

9. The communication terminal according to claim 7, wherein the first radio access technology is a cellular mobile communication network radio access technology.

10. The communication terminal according to claim 9, wherein the first radio access technology is an LTE radio access technology.

11. The communication terminal according to claim 7, wherein the second radio access technology is a local area network radio access technology.

12. The communication terminal according to claim 11, wherein the second radio access technology is a WLAN radio access technology.

13. The communication terminal according to claim 7, wherein the first frequency band is different from the second frequency band.

14. The communication terminal according to claim 7, being configured to operate a radio cell using the second radio access technology and the second frequency band.

15. The communication terminal according to claim 1, further comprising a signaling circuit configured to signal to the cellular mobile communication network that the NAS bearer connection is to be associated with the at least one second communication terminal.

16. The communication terminal according to claim 1, further comprising a signaling circuit configured to signal to the cellular mobile communication network that the NAS bearer connection associated with the at least one second communication terminal is to be released.

17. The communication terminal according to claim 1, wherein the controller is configured to control the communication terminal to exchange data between the at least one second communication terminal and the core network using the NAS bearer connection according to a quality of service associated with the NAS bearer connection.

18. The communication terminal according to claim 1, wherein the communication module is configured to establish a further NAS bearer connection between the communication terminal and the core network.

19. The communication terminal according to claim 18, wherein the controller is configured to control the communication terminal to dedicatedly exchange data between a second communication terminal of the at least one second communication terminal and the core network using the NAS bearer connection and to dedicatedly exchange data between another communication terminal of the at least one second communication terminal and the core network using the further NAS bearer connection.

20. The communication terminal according to claim 18, wherein the controller is configured to control the communication terminal to exchange data using the NAS bearer connection according to a quality of service associated with the further NAS bearer connection.

21. The communication terminal according to claim 20, wherein the quality of service associated with the NAS bearer connection is different from the quality of service associated with the further NAS bearer connection.

22. A method for exchanging data comprising:
establishing an NAS bearer connection between a communication terminal and a core network of a cellular mobile communication network;
controlling the communication terminal to dedicatedly use the NAS bearer connection to exchange data between at least one second communication terminal communicating with the communication terminal and the core network.

23. A communication device comprising:
a receiver configured to receive a request from a first communication terminal to establish an NAS bearer connection between the first communication terminal and a core network of a cellular mobile communication network and to associate the NAS bearer connection with at least one second communication terminal communicating with the first communication terminal; and
a controller configured to establish an NAS bearer connection between the first communication terminal and the core network and to associate the NAS bearer connection with the at least one second communication terminal.

24. The communication device according to claim 23, further comprising a radio module exchanging data with the at least one second communication terminal via the first communication terminal using the NAS bearer connection.

25. The communication device according to claim 23, wherein the receiver is further configured to receive a request to release the NAS bearer connection and the controller is configured to release the NAS bearer connection in response to the release request.

26. The communication device according to claim 23, being a network entity of the cellular mobile communication network.

27. A method for establishing a communication connection comprising:
receiving a request from a first communication terminal to establish an NAS bearer connection between the first communication terminal and a core network of a cellular mobile communication network and to associate the NAS bearer connection with at least one second communication terminal communicating with the first communication terminal;
establishing an NAS bearer connection between the first communication terminal and the core network; and
associating the NAS bearer connection with the at least one second communication terminal.
